(19) United States
(12) Patent Application Publication
(10) Pub. No.: US 2023/0346046 A1
(43) Pub. Date: Nov. 2, 2023

(54) AEROSOL GENERATION SYSTEM WITH EVACUATED THERMAL INSULATION REGION

(71) Applicant: NICOVENTURES TRADING LIMITED, LONDON (GB)

(72) Inventors: Scott George BOHAM, London (GB); Gary FALLON, London (GB)

(21) Appl. No.: 18/245,177

(22) PCT Filed: Sep. 13, 2021
(86) PCT No.: PCT/EP2021/075114

§ 371 Date: Mar. 14, 2023

(30) Foreign Application Priority Data
Sep. 14, 2020 (GB) 2014441.6

(51) Int. Cl. A24F 40/70; A24F 40/465; A24F 40/20; F16L 59/065; H05B 6/10

(52) U.S. Cl. CPC A24F 40/70; A24F 40/465; A24F 40/20; F16L 59/065; H05B 6/105

(57) ABSTRACT

A method for manufacturing a thermal insulator includes providing an inner wall which is configured to at least partially define a heating zone for receiving aerosol-generating material, wherein the inner wall includes heating material that is heatable by penetration with a varying magnetic field, and providing an outer wall surrounding the inner wall at least partially along its length, an insulation region being formed between the inner wall and the outer wall, the inner wall and outer wall having different materials. The method can also include attaching a portion of a first joining material to the inner wall under atmospheric pressure, attaching a portion of a second joining material to the outer wall under atmospheric pressure, evacuating the insulation region to a pressure lower than atmospheric pressure, and closing the insulation region by joining the first joining material and second joining material to each other.

### PRIORITY CLAIM

The present application is a National Phase entry of PCT Application No. PCT/EP2021/075114, filed Sep. 13, 2021, which claims priority from GB Application No. 2014441.6, filed Sep. 14, 2020, each of which hereby fully incorporated herein by reference.

### TECHNICAL FIELD

The present invention relates to a method for manufacturing insulation for use with an aerosol provision device and to a thermal insulator made by that method.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to a first aspect of the present disclosure, there is provided a method for manufacturing a thermal insulator, the method comprising: providing an inner wall which is configured to at least partially define a heating zone for receiving aerosol-generating material, wherein the inner wall comprises heating material that is heatable by penetration with a varying magnetic field; providing an outer wall surrounding the inner wall at least partially along its length, an insulation region being formed between the inner wall and the outer wall, the inner wall and outer wall comprising different materials; attaching a portion of a first joining material to the inner wall under atmospheric pressure; attaching a portion of a second joining material to the outer wall under atmospheric pressure; evacuating the insulation region to a pressure lower than atmospheric pressure; and closing the insulation region by joining the first joining material and second joining material to each other.

According to a second aspect of the present disclosure, there is provided a method for manufacturing a thermal insulator, the method comprising: providing an inner wall which is configured to at least partially define a heating zone for receiving at least a portion of an article comprising smokable material, wherein the inner wall comprises heating material that is heatable by penetration with a varying magnetic field; providing an outer wall surrounding the inner wall at least partially along its length, an insulation region being formed between the inner wall and the outer wall; evacuating the insulation region to a pressure lower than atmospheric pressure; and closing the insulation region by joining the inner wall and outer wall using an adhesive.

According to a third aspect of the present disclosure, there is provided a method for manufacturing a thermal insulator, the method comprising: providing an inner wall which is configured to at least partially define a heating zone for receiving at least a portion of an article comprising smokable material, wherein the inner wall comprises heating material that is heatable by penetration with a varying magnetic field; providing an outer wall surrounding the inner wall at least partially along its length, an insulation region being formed between the inner wall and the outer wall; providing one or more joining members; joining each of the one or more joining members to the inner wall; evacuating the insulation region to a pressure lower than atmospheric pressure; and closing the insulation region by joining at least one of the one or more joining members to the outer wall.

According to a fourth aspect of the present disclosure, there is provided a thermal insulator manufactured according to any of the first three aspects of the present disclosure.

According to a fifth aspect of the present disclosure, there is provided a non-combustible aerosol provision device comprising: a thermal insulator according to the fourth aspect of the present disclosure; and a magnetic field generator for generating a varying magnetic field that penetrates the inner wall in order to heat the inner wall, in use.

According to a sixth aspect of the present disclosure, there is provided a non-combustible aerosol provision system, comprising: an apparatus according to the fifth aspect of the present disclosure; and aerosol-generating material located at least partially within the heating zone of the inner wall of the thermal insulator, in use.

Further features and advantages of the invention will become apparent from the following description of preferred embodiments of the invention, given by way of example only, which is made with reference to the accompanying drawings.

### BRIEF DESCRIPTION OF THE DRAWINGS

Embodiments of the invention will now be described, by way of example only, with reference to the accompanying drawings, in which:

FIG. 1 shows a schematic cross-sectional view of an example aerosol provision device;

FIG. 2 shows a schematic cross-sectional view of an example thermal insulator for use in the apparatus of FIG. 1;

FIG. 3 shows a section along line A-A of FIG. 2;

FIG. 4 shows a schematic cross-sectional view of a further example of a thermal insulator for use with an aerosol provision device, illustrating a method for connecting an outer wall of the thermal insulator to an inner wall of the thermal insulator using joining material;

FIG. 5 shows a schematic cross-sectional view of another example of a thermal insulator for use with an aerosol provision device, illustrating a method for connecting an outer wall of the thermal insulator to an inner wall of the thermal insulator using adhesive;

FIG. 6 shows a schematic cross-sectional view of a further example of a thermal insulator for use with an aerosol provision device, illustrating a method for connecting an outer wall of the thermal insulator to an inner wall of the thermal insulator using joining members in the form of end caps

FIG. 7 shows a schematic cross-sectional view of another example of a thermal insulator, showing how the thermal insulator of FIG. 6 may be positioned relative to a heating coil and magnetic shielding in an aerosol provision device.

### DETAILED DESCRIPTION

As used herein, the term “aerosol-generating material” includes materials that provide volatilized components upon heating, typically in the form of an aerosol. Aerosol-generating material includes any tobacco-containing material and may, for example, include one or more of tobacco, tobacco derivatives, expanded tobacco, reconstituted tobacco or tobacco substitutes. Aerosol-generating material also may include other, non-tobacco, products, which, depending on the product, may or may not contain nicotine. Aerosol-generating material may for example be in the form of a solid, a liquid, a gel, a wax or the like. Aerosol-generating material may for example also be a combination or a blend of materials. Aerosol-generating material may also be known as “smokable material”.

Apparatus is known that generates aerosol from an aerosol-generating material using an aerosol generator. One particularly common way of generating aerosol is by heating the aerosol-generating material. In such an apparatus, the aerosol generator is a heater which heats aerosol-generating material to volatilize at least one component of the aerosol-generating material, typically to form an aerosol which can be inhaled, without burning or combusting the aerosol-generating material. Such apparatus is sometimes described as an “aerosol provision device”, a “heat-not-burn device”, a “tobacco heating product device” or a “tobacco heating device” or similar. Similarly, there are also so-called e-cigarette devices, which typically vaporize an aerosol-generating material in the form of a liquid, which may or may not contain nicotine. The aerosol-generating material may be in the form of or be provided as part of a rod, cartridge or cassette or the like which can be inserted into the apparatus. An aerosol generator for volatilizing the aerosol-generating material may be provided as a “permanent” part of the apparatus or could be combined with the aerosol-generating material in a replaceable or consumable component. In the present disclosure, the focus will be on an aerosol generator which is a heater; however, it should be understood that alternative ways of generating aerosol from an aerosol-generating material are also available.

An aerosol provision device can receive an article comprising aerosol-generating material for heating. An “article” in this context is a component that includes or contains, in use, the aerosol-generating material, which is heated to volatilize the aerosol-generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article. Alternatively, aerosol-generating material can simply be located in a free or unconstrained manner in a heating chamber of a device; loose leaf tobacco, for example, could be used in this way.

Induction heating is a process in which an electrically conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating. An object that is capable of being inductively heated is known as a susceptor.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically conductive and magnetic, penetrating the object with a varying magnetic field can cause both Joule heating and magnetic hysteresis heating in the object. Moreover, the use of magnetic material can strengthen the magnetic field, which can intensify the Joule and magnetic hysteresis heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

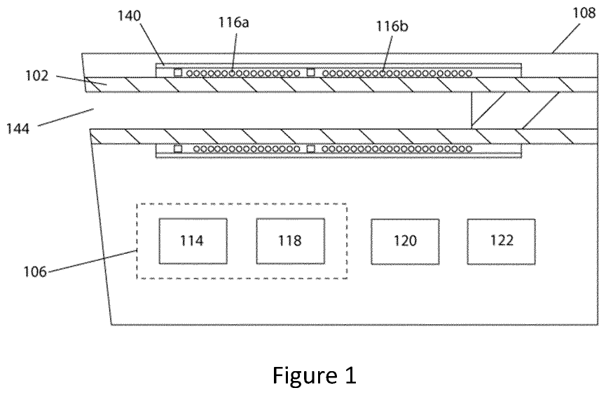

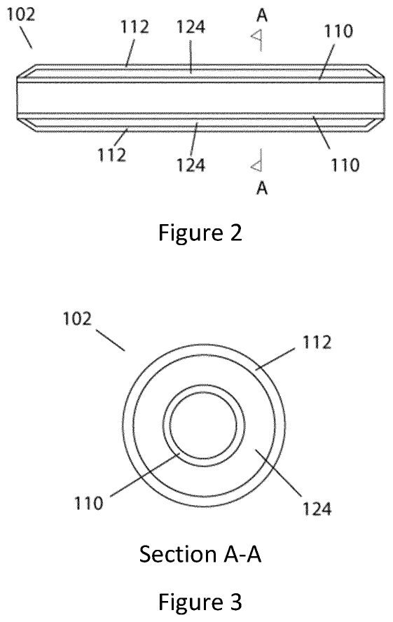

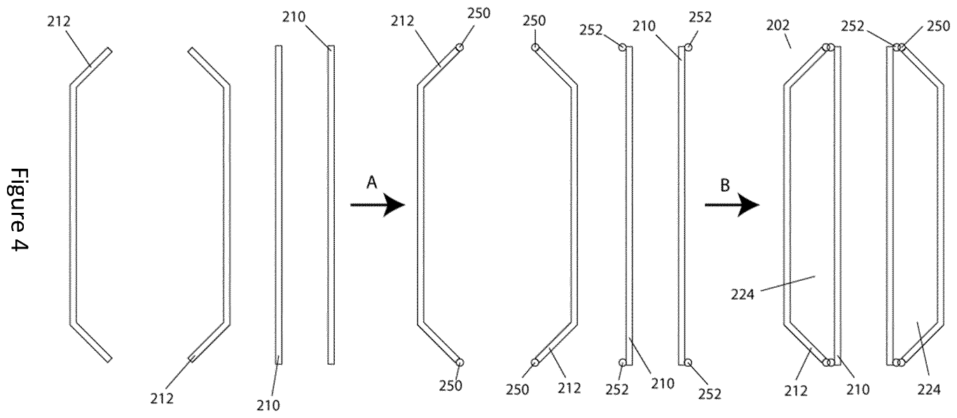

FIG. 1 shows a schematic cross-sectional view of an aerosol provision device 100 according to an example of the invention. FIGS. 2 and 3 show schematic cross-sectional views of an example thermal insulator 102 for use in the aerosol provision device 100. The thermal insulator 102 is shown in simplified form in FIG. 1, for clarity. The thermal insulator 102 of the aerosol provision device 100 is configured for receiving aerosol-generating material (not shown) that is to be heated, in that it comprises a heating chamber or zone 144. The aerosol-generating material may be inserted into an opening of the heating chamber 144 in the aerosol provision device 100. The aerosol provision device 100 includes a magnetic field generator 106 for generating a varying magnetic field in use and a housing 108 for housing each of the components of the aerosol provision device 100.

In this example, the magnetic field generator 106 comprises an electrical power source 114 and a device 118 for passing a varying electrical current, such as an alternating current, through a two-part coil 116a, 116b. In some examples, such as that illustrated in FIG. 1, the magnetic field generator 106 is also connected to a controller 120 and a user interface 122 for user-operation of the controller 120.

The electrical power source 114 may be a rechargeable battery (such as a lithium ion battery), a non-rechargeable battery, a capacitor, a battery-capacitor hybrid, or a connection to a mains electricity supply.

The coil 116a, 116b may take any suitable form, including the form of a single coil with two portions; a single portion coil is also possible as an alternative. In the example illustrated in FIG. 1, the two-part coil 116a, 116b is a helical coil made of an electrically conductive material, such as copper. In some examples, the coil 116a, 116b may be a flat coil. That is, the coil may be a pseudo two-dimensional spiral. In some examples, the coil may comprise a Litz wire.

The aerosol provision device 100 includes an air inlet (not shown) that fluidly connects an interior of the apparatus with an exterior of the aerosol provision device 100. In use, a user may be able to inhale a volatilized component(s) of the aerosol-generating material. As the volatilized component(s) is/are removed from the aerosol-generating material, air may be drawn into the aerosol provision device 100 via the air inlet.

The thermal insulator 102 is shown in more detail in FIGS. 2 and 3 and includes an inner wall 110 and an outer wall 112. The inner wall 110 is a heating element comprising or made of heating material that is heatable by penetration with a varying magnetic field. In one example, the inner wall 110 may be formed of mild steel. Mild steel is inexpensive, easily workable and is a susceptor. In another example, the inner wall 110 may be formed of ferritic stainless steel. Ferritic stainless steel is easily workable, has good corrosion resistance and is a susceptor. However, a nickel-cobalt ferrous alloy, such as Kovar®, could also be used. The heating chamber or heating zone 144 is encircled by the inner wall 110. As a result, the inner wall 110 at least partially defines the heating chamber/zone 144. In use, the aerosol-generating material to be heated is received in the heating chamber/zone 144 within the inner wall 110. In FIGS. 2 and 3, the thermal insulator 102 is shown as being substantially cylindrical with a circular cross-sectional shape. In other examples, the thermal insulator 102 may have a different cross-sectional shape.

Referring to FIGS. 2 and 3, the example thermal insulator 102 shown includes an insulation region 124 bounded by and arranged between the inner wall 110 and the outer wall 112. In the depicted example, the insulation region 124 encircles the inner wall 110 and the outer wall 112 encircles the insulation region 124, as is illustrated clearly in FIG. 3. The insulation region 124 is evacuated to a pressure lower than atmospheric pressure, as would be expected to be present in a region exterior of the insulation region. In some examples, the pressure lower than atmospheric pressure is 10⁻¹ Torr or lower. Providing an insulation region 124 which is at a pressure lower than atmospheric pressure thermally insulates the inner wall 110 and the heating chamber/zone 144 from the outer wall 112 and the housing 108, thereby limiting heat transfer away from the inner wall 110 and the heating chamber/zone 144 into the rest of the aerosol provision device 100, exterior to the heating chamber/zone 144. This is advantageous because other components of an aerosol provision device 100, such as the electrical power source 114, may be sensitive to increases in temperature. It is well known, for example, that batteries may be damaged or even dangerous if exposed to high temperatures. Furthermore, heat transfer to the housing 108 of the aerosol provision device 100 may cause discomfort or even injury to the user, in use.

The pressure in the insulation region 124 may be in the range of 10-1 to 10-7 torr. In some examples, the pressure in the insulating region 124 is considered to be a vacuum. The inner wall 110 and the outer wall 112 of the thermal insulator 102 are sufficiently strong to withstand any force exerted against them due to the pressure differential between the insulation region 124 and regions external to the inner wall 110 and the outer wall 112, thereby preventing the thermal insulator 102 from collapsing inwards. A gas-absorbing material may be used in the insulation region 124 to maintain or aid creation of a relatively low pressure in the insulation region 124.

Providing an insulation region 124 at a pressure lower than atmospheric pressure is particularly advantageous because it allows for very effective thermal insulation to be provided in an area which is much smaller in size than may be possible with alternative thermal insulation options. This in turn allows for the overall size of the aerosol provision device 100 to be kept to a minimum, without compromising the thermal insulation of the heating chamber/zone 144. Furthermore, as the inner wall 110 functions as both a heating element and a wall of the thermal insulator 102, the overall size and weight of the aerosol provision device 100 can be reduced as there is no requirement to include a separate heating element and a separate insulation component. The inner wall 110 is able to function as both a heating element and a wall of the thermal insulator 102 because it is conveniently heatable by induction heating. Induction heating also beneficially does not require a physical connection to be provided between a source of a varying magnetic field and a heating element, which removes the requirement for wires or any other physical connection between the power source and the heating element.

FIG. 3 shows a section through line A-A of FIG. 2. FIGS. 2 and 3 are not drawn to scale. In FIG. 2, the outer wall 112 is shown as extending along the entire length of the inner wall 110. However, in an alternative example the outer wall 112 may extend only partially along a length of the inner wall 110. That is, the outer wall 112 may extend along only a portion of the inner wall 110, such that thermal insulation may be provided around only a portion of the inner wall 110. Providing an outer wall 112 that extends only part of the way along the length of the inner wall 110 could allow for the overall size of the aerosol provision device 100 to be further reduced. The outer wall 112 and the inner wall 110 are shown as being co-axial with one another, although this is not essential.

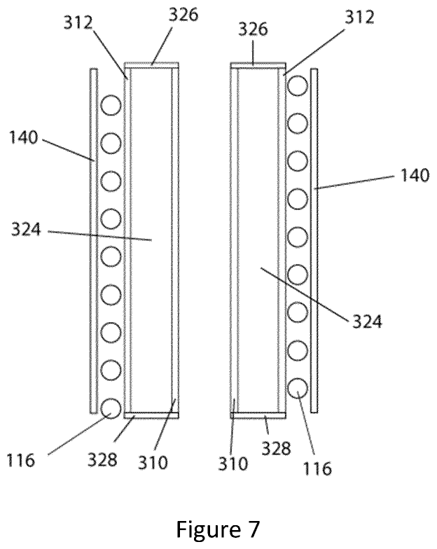

As shown in FIG. 1, the coil 116a, 116b encircles at least part of the thermal insulator 102. Specifically, the coil 116a, 116b encircles at least part of the outer wall 112 of the thermal insulator 102. As illustrated in FIGS. 1 and 7, magnetic shielding 140 is provided around at least part of the coil 116a, 116b or 116. The magnetic shielding 140 is used to reduce or avoid interaction between the magnetic field generated by the magnetic field generator 106 and anything other than the heating element, i.e. the inner wall 110. The magnetic shielding can be formed of any material(s) suitable for containing a magnetic field, such as a ferrite material.

In some examples, the outer wall 112 is formed from a non-susceptible and electrically non-conductive material, such that the outer wall 112 will not be significantly heated by induction heating when exposed to a varying magnetic field. In some examples, the outer wall 112 comprises one or more of: a non-susceptible metallic material, or a plastic, glass or ceramic material. Providing an outer wall 112 of a non-susceptible material means that, when a varying electrical current, such as an alternating current, is passed through the coil 116a, 116b, the inner wall 110 of the thermal insulator 102 will be heated, whereas the outer wall 112 will not be heated by induction heating. Therefore, the efficiency of the system and the thermal management within the system can be improved, as energy will not be wasted heating the outer wall 112 and excessive temperature rises in the outer wall 112 will not need to be controlled and/or mitigated.

If the outer wall 112 were to be heated by virtue of the varying electrical current, the inner wall 110 may in fact only be heated minimally, which would be undesirable. This arrangement also serves to keep an outside temperature of the housing 108, particularly at its surface, at an acceptable level for handling by a user. Non-susceptible metals are generally inexpensive and easily workable and/or machinable; plastic is inexpensive, easily formable and tough; and glass is inexpensive, easily formable and has good strength, whereas ceramic materials are strong, tough and lightweight. A suitable plastic material could be a polymer which is thermally and mechanically stable up to at least 250 degrees Celsius, possibly to at least 320 degrees Celsius; an example of such a polymer is polyether ether ketone (PEEK). A suitable glass material could be borosilicate glass, which has a low coefficient of thermal expansion, making it particularly resistant to thermal shock. A suitable ceramic material could be zirconia. A composite material comprising more than one of the materials listed above, such as a glass-reinforced plastic, may allow for the beneficial properties of the materials to be combined.

In order to manufacture a thermal insulator with a closed insulation region, which is necessary when the insulation region is to be maintained at a pressure lower than atmospheric pressure, an inner wall and an outer wall of the thermal insulator must be connected. As previously noted, it is advantageous for the inner wall to be heatable by penetration with a varying magnetic field, while the outer wall is not heatable by penetration with a varying magnetic field. Thus, the inner wall comprises a material that is a susceptor, while the outer wall comprises a material that is not a susceptor. Directly joining dissimilar materials under lower than atmospheric pressure conditions using methods such as brazing, welding and soldering can lead to manufacturing difficulties. For example, many common welding techniques require the presence of an inert gas, and so cannot be performed in a vacuum. The methods described below according to the first, second and third aspects of the present disclosure solve this problem by providing improved ways of connecting an inner wall and an outer wall comprising dissimilar materials, when manufacturing a thermal insulator comprising an outer and an inner wall to contain a low pressure insulation region.

FIG. 4 schematically illustrates steps of a method for manufacturing a thermal insulator 202 according to a first aspect of the present disclosure. The first step of the method, illustrated at the bottom of FIG. 4, comprises providing an inner wall 210 and an outer wall 212. The inner wall 210 is configured to at least partially define a heating chamber or heating zone for receiving aerosol-generating material (not shown), in that the inner wall 210 comprises heating material that is heatable by penetration with a varying magnetic field. In some examples, the inner wall 210 comprises mild steel. Mild steel is an advantageous material because it is inexpensive, easily workable and is a susceptor. In other examples, the inner wall 110 comprises ferritic stainless steel. Ferritic stainless steel an advantageous material because it is easily workable, has good corrosion resistance and is a susceptor. The outer wall 212 is configured to surround the inner wall 210 at least partially along its length, so that an insulation region 224 is formed between the inner wall 210 and the outer wall 212. In order to avoid the outer wall 212 being heated by the varying magnetic field that is applied to heat the inner wall 210, the outer wall 212 comprises a different material from that of the inner wall 210. As discussed above, in some examples, the outer wall comprises one or more of: a non-susceptible metallic material, or a plastic, glass or ceramic material. Non-susceptible metals are generally inexpensive and easily workable and/or machinable; plastic is inexpensive, easily formable and tough; and glass is inexpensive, easily formable and has good strength, whereas ceramics are strong, tough and lightweight. Non-susceptible metals, plastics, glasses and ceramics are all not significantly heatable by penetration with a varying magnetic field. A suitable plastic material could be a polymer which is thermally and mechanically stable up to at least 250 degrees Celsius, possibly to at least 320 degrees Celsius; an example of such a polymer is polyether ether ketone (PEEK). A suitable glass material could be borosilicate glass, which has a low coefficient of thermal expansion, making it particularly resistant to thermal shock. A suitable ceramic material could be zirconia. A composite material comprising more than one of the materials listed above, such as a glass reinforced plastic, may allow for the beneficial properties of the materials to be combined.

The second step of the method according to the first aspect of the present disclosure is illustrated by arrow A in FIG. 4. Under normal atmospheric pressure, a portion of a first joining material 250 is attached to the outer wall 212 and a portion of a second joining material 252 is attached to the inner wall 210. The first joining material 250 and the second joining material 252 are made of similar materials. However, each of the first joining material 250 and the second joining material 252 are dissimilar materials to those which the inner wall 210 and the outer wall 212 comprise. In some examples, the first joining material 30 and second joining material 252 are identical to one another. In some examples, the first joining material 250 and the second joining material 252 are attached to the outer wall 212 and inner wall 210 respectively by brazing, welding or soldering. Brazing forms a bond with good strength and can be used to join closely fitting parts together; welding forms a bond with very high strength; and soldering forms a bond with reasonable strength while using much lower heating temperatures than may be required for either brazing or welding. The first joining material 250 may be joined to the outer wall 212 by a different method to the method used to join the second joining material 252 to the inner wall 210, or the methods used may be the same.

It is advantageous that the dissimilar materials of the outer wall 212 and the first joining material 250, and the inner wall 210 and the second joining material 252, respectively are joined under normal atmospheric pressure. As discussed above, joining dissimilar materials is easier under normal atmospheric pressure than under a pressure lower than normal atmospheric pressure.

A third step of the method according to the first aspect of the present disclosure is illustrated in by arrow B in FIG. 4. The insulation region 224 is evacuated to a pressure lower than atmospheric pressure. The insulation region 224 is then closed by joining the first joining material 250 and the second joining material 252 to each other. As discussed above, the first joining material 250 and the second joining material 252 comprise similar materials, and in some examples comprise identical materials. In some examples, the first and/or second joining material is a silver eutectic braze material. Silver eutectic alloys are suitable for a wide range of brazing applications. Silver eutectic alloys can also be effective for joining together dissimilar materials, as is required in the second step of the presently described method, and can be used in vacuum conditions, as is required in the third step of the method.

In order to form and maintain an insulation region 224 with a pressure lower than atmospheric pressure, the insulation region must be closed under a pressure lower than atmospheric pressure. The method according to the first aspect of the present disclosure, as described above, has the advantage that only similar materials are joined to one another under a pressure lower than atmospheric pressure. As noted previously, this is an easier manufacturing step than joining dissimilar materials under a pressure lower than atmospheric pressure. Thus, the method according to the first aspect of the present disclosure reduces the complexity of manufacturing the thermal insulator 202.

In some examples, when the insulation region 224 is evacuated to a pressure lower than atmospheric pressure, a region external to the insulation region 224 is also evacuated to a pressure lower than atmospheric pressure. This may be achieved, for example, by performing the second step of the method according to the second aspect of the present disclosure in a vacuum chamber.

In some examples, the pressure lower than atmospheric pressure is 10⁻¹ Torr or lower. As previously discussed, lowering the pressure within the insulation region improves the thermal insulation properties of the insulation region. A pressure within the insulation region 224 of 10⁻¹ Torr or lower provides the closed insulation region 224 with good thermal insulation properties.

The method illustrated in FIG. 4 and described above includes steps of joining the first joining material 250 to the second joining material 252 under low pressure conditions at both ends of a thermal insulator 202. However, it should be appreciated that joining more than one first joining material 250 and second joining material 252 according to this method is not essential when manufacturing a single thermal insulator 202. According to the first aspect of the present disclosure, the method of joining of the first joining material 250 and the second joining material 252 is performed under low pressure conditions in order to close the insulation region 224; such a step could be performed at only one end of a thermal insulator 202, the other end having first been joined under normal atmospheric conditions. Thus, the method according to the first aspect of the present disclosure requires only that the special conditions outlined above (joining the first joining material 250 and the second joining material 252 under low pressure conditions) be used for the final joining performed in order to close the insulation region 224, although using this method for performing other joinings is, of course, not precluded.

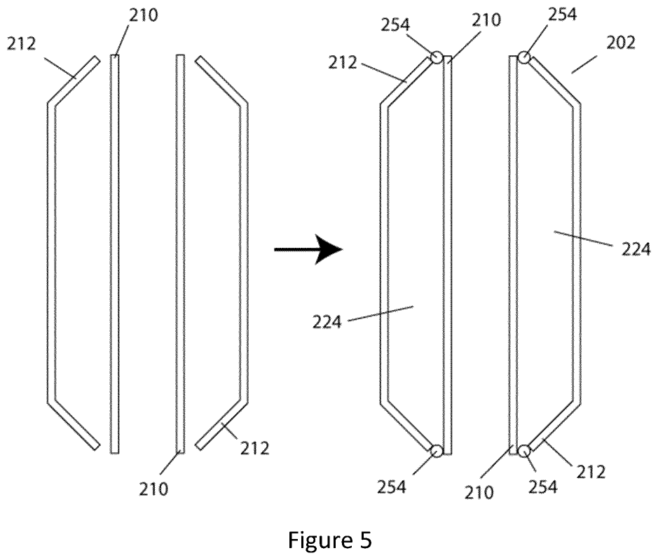

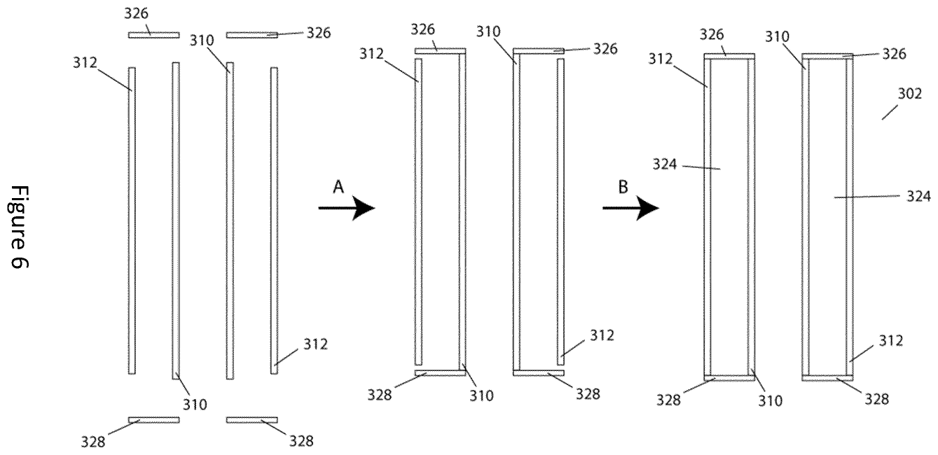

FIG. 5 illustrates a method for manufacturing a thermal insulator 202 according to a second aspect of the present disclosure. The first step of the method, illustrated on the left-hand side of FIG. 5, comprises providing an inner wall 210 and an outer wall 212, in the same way as described regarding the first aspect of the present disclosure, above.

The second step of the method according to the second aspect of the present disclosure is illustrated on the right-hand side of FIG. 5. The insulation region 224 is evacuated to a pressure lower than atmospheric pressure. The insulation region 224 is then closed by joining the outer wall 212 to the inner wall 210 through the use of an adhesive 254. Adhesives have the advantage of being able to join together a wide range of materials, regardless of whether they are similar or dissimilar to one another. Generally, a bond formed by an adhesive exhibits excellent strength, toughness and resistance to chemical and thermal degradation. By using an adhesive 254, the method according to the second aspect of the present disclosure avoids the difficulties of joining dissimilar materials under low pressure conditions which can occur when using brazing, welding or soldering. Examples of suitable adhesives may be a two-part epoxy, a one-part epoxy or an acrylic-based adhesive.

In some examples, when the insulation region 224 is evacuated to a pressure lower than atmospheric pressure, a region external to the insulation region 224 is also evacuated to a pressure lower than atmospheric pressure. This may be achieved, for example, by performing the second step of the method according to the second aspect of the present disclosure in a vacuum chamber. This has the advantage that the adhesive 254 can be applied under conditions where the difference in pressure between the insulation region 224 and the region external to the insulation region 224 is insignificant. This may allow for the adhesive 254 to be used to join the inner wall 210 and the outer wall 212 more easily than if the region external to the insulation region 224 was maintained at atmospheric pressure. For example, the absence of a pressure difference may allow for the adhesive to be applied more accurately. Furthermore, adhesives are usually applied in liquid form and require at least a short period of time to solidify and form a bond; removing the pressure difference between the insulation region 224 and the region external to the insulation region 224 may allow the adhesive to solidify and strengthen without being disturbed by the pressure differential which would otherwise be present.

Some adhesives require time to cure after being applied, in order for the adhesive bond to become effective and/or stronger. In examples where such an adhesive is used, curing may be facilitated by evacuating the region in which the adhesive is present to a pressure lower than atmospheric pressure; this is specifically the case for vacuum-cured adhesives. Such adhesives may be cured by applying heat and/or ultraviolet light. By ensuring that pressure within the insulation region 224, and pressure external to the insulation region 224, are maintained at a pressure below atmospheric pressure, such vacuum curing can be achieved.

As with the first aspect of the present disclosure (discussed above in more detail and illustrated in FIG. 4), it is not essential that the method according to the second aspect of the present disclosure be used to join the inner wall 210 and the outer wall 212 at both ends of the thermal insulator 202, as illustrated in FIG. 5. For example, the inner wall 210 and the outer wall 212 may first be joined at one end of the thermal insulator 202 under normal atmospheric conditions, before the insulation region 224 is evacuated and the inner wall 210 and the outer wall 212 are joined at the second end using an adhesive 254 in order to close the insulation region 254. Thus, as with the first aspect, the method according to the second aspect of the present disclosure requires only that the final joining in order to close the insulation region 224 be performed according to the special conditions outlined above (evacuating the insulation region 224 and then closing the insulation region 224 by joining the outer wall 212 to the inner wall 210 using an adhesive 254), although using such a method to perform other joinings is, of course, not precluded.

FIG. 6 illustrates a method for manufacturing a thermal insulator 302 according to a third aspect of the present disclosure. The first step of the method, illustrated at the bottom of FIG. 6, comprises providing an inner wall 310 and an outer wall 312, in the same way as described regarding the first and second aspects of the present disclosure, above. One or more joining members are also provided; in the example illustrated in FIG. 6, there is provided a first joining member 326 and a second joining member 328.

The second step of the method according to the third aspect of the present disclosure is illustrated by the arrow A in FIG. 6. Under normal atmospheric pressure, the first joining member 326 and the second joining member 328 are joined to the inner wall 310. It is to be expected that the material of the inner wall 310 would be different from the materials of the first joining member 326 and the second joining member 328; otherwise, the first joining member 326 and the second joining member 328 would be susceptible to heating by the application of a magnetic field in a similar way to the inner wall 310. In some examples, the method of joining each of the joining members to the inner wall 310 is brazing, welding, soldering, an adhesive or an interference fit.

The third step of the method according to the third aspect of the present disclosure is illustrated by the arrow B of FIG. 6. The insulation region 324 is evacuated to a pressure lower than atmospheric pressure. The insulation region 324 is then closed by joining each of the first joining member 326 and the second joining member 328 to the outer wall 312. In some examples, the method of joining each of the joining members to the inner wall 310 is brazing, welding, soldering, an adhesive or an interference fit.

Providing one or more joining members, as is required by the method according to the third aspect of the disclosure, is advantageous because it avoids the requirement for the inner wall 310 and the outer wall 312 to be directly joined to one another. As discussed above, joining dissimilar materials under low pressure conditions can lead to manufacturing difficulties. The materials requirements for the inner wall 310 and the outer wall 312 may be fairly restrictive; for example, the inner wall 310 must be a susceptor for it to be heated by induction heating, and both the inner wall 310 and the outer wall 312 must be capable of supporting the mechanical stress resulting from maintaining a relatively low pressure in the insulation region 324. The materials requirements for the one or more joining members may be less restrictive, thus allowing for a choice of material that could be more easily joined to the outer wall 312 and/or inner wall 310. In some examples, the outer wall 312 and the first and second joining members 326, 328 comprise similar or identical materials. Thus, the method according to the third aspect of the present invention allows for the dissimilar materials of the inner wall 310 and the first and second joining members 326, 328 to be joined under atmospheric conditions, while the similar materials of the first and second joining members 326, 328 and the outer wall 312 are subsequently joined under lower pressure conditions to close the insulation region 324.

In examples where two or more joining members are used, it should be understood that only the joining of a final joining member to the outer wall must be done under low pressure conditions, in order to close the insulation region. For example, if two joining members 326, 328 are used, it would be possible to join the first and second joining members 326, 328 to the inner wall 310, and to join one of the joining members to the outer wall 312, all under normal atmospheric conditions. The pressure in the insulation region could then be lowered, and the remaining joining member joined to the outer wall 312 to close the insulation region 324. Even joining similar materials under low pressure conditions can present manufacturing difficulties, and so performing only a single joining under low pressure conditions in this manner would be advantageous.

The use of one or more joining members located between the outer wall 312 and the inner wall 310 may allow for at least one of the joins between these components to be an interference fit. An interference fit has the advantage of manufacturing simplicity and also avoids the need for heat and/or additional materials such as a braze material or adhesive in the joining process. The use of an interference fit is particularly advantageous in examples where the one or more joining members are end caps, each configured to be located at an end of the outer wall 312 and inner wall 310. When using end caps, external pressure resulting from the relatively low pressure within the insulation region 324 helps to secure the joining members in position, and thus a connection achieved by an interference fit would be additionally secured by this pressure. It should also be noted that when using one or more end caps, the external pressure also helps to secure any other form of join between the one or more end caps and the outer wall 312 and inner wall 310.

FIG. 7 illustrates an example of a thermal insulator 302 manufactured according to the method of the third aspect of the present disclosure, surrounded by a single induction coil 116, which is in turn surrounded by a magnetic shield 140 of an aerosol provision device.

A fourth aspect of the present disclosure describes a thermal insulator manufactured according to any of the methods described in the previous aspects of the present disclosure. It is understood that by providing improved production methods, the thermal insulator produced according to the improved methods will be more robust than alternative thermal insulation products.

A fifth aspect of the present disclosure describes an aerosol provision device comprising a thermal insulator according to the fourth aspect of the present disclosure; and a magnetic field generator for generating a varying magnetic field that penetrates the inner wall in order to heat the inner wall, in use. An example of an aerosol provision device according to the present disclosure is discussed in more detail above, in relation to FIG. 1.

A sixth aspect of the present disclosure describes an aerosol provision system, comprising: an apparatus according to the fifth aspect of the present disclosure; and aerosol-generating material located at least partially within the heating zone of the inner wall of the thermal insulator, in use.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method for manufacturing a thermal insulator, the method comprising:
providing an inner wall which is configured to at least partially define a heating zone for receiving aerosol-generating material, wherein the inner wall comprises heating material that is heatable by penetration with a varying magnetic field;
providing an outer wall surrounding the inner wall at least partially along its length, an insulation region being formed between the inner wall and the outer wall, the inner wall and outer wall comprising different materials;
attaching a portion of a first joining material to the inner wall under atmospheric pressure;
attaching a portion of a second joining material to the outer wall under atmospheric pressure;
evacuating the insulation region to a pressure lower than atmospheric pressure; and
closing the insulation region by joining the first joining material and second joining material to each other.

2. A method according to claim 1, wherein when the insulation region is evacuated to a pressure lower than atmospheric pressure, a region external to the insulation region is also evacuated to a pressure lower than atmospheric pressure.

3. A method according to claim 1, wherein the portions of the first and second joining materials are attached to at least one of the inner and outer walls by brazing, welding or soldering.

4. A method according to claim 1, wherein the first and second joining materials are joined to each other by brazing, welding or soldering.

5. A method according to claim 1, wherein the first and second joining materials comprise a silver eutectic braze material.

6. A method for manufacturing a thermal insulator, the method comprising:
providing an inner wall which is configured to at least partially define a heating zone for receiving at least a portion of an article comprising smokable material, wherein the inner wall comprises heating material that is heatable by penetration with a varying magnetic field;
providing an outer wall surrounding the inner wall at least partially along its length, an insulation region being formed between the inner wall and the outer wall;
evacuating the insulation region to a pressure lower than atmospheric pressure; and
closing the insulation region by joining the inner wall and outer wall using an adhesive.

7. A method according to claim 6, wherein the inner wall and outer wall comprise different materials.

8. A method according to claim 6, wherein when the insulation region is evacuated to a pressure lower than atmospheric pressure, a region external to the insulation region is also evacuated to a pressure lower than atmospheric pressure.

9. A method according to claim 8, wherein the adhesive is cured while a region external to the insulation region is at a pressure lower than atmospheric pressure.

10. A method according to claim 6, wherein the adhesive is one of: a two-part epoxy, a one-part epoxy or an acrylic-based adhesive.

11. A method according to claim 10, wherein the adhesive is be cured by heat and/or ultraviolet light.

12. A method for manufacturing a thermal insulator, the method comprising:
providing an inner wall which is configured to at least partially define a heating zone for receiving at least a portion of an article comprising smokable material, wherein the inner wall comprises heating material that is heatable by penetration with a varying magnetic field;
providing an outer wall surrounding the inner wall at least partially along its length, an insulation region being formed between the inner wall and the outer wall;
providing one or more joining members;
joining each of the one or more joining members to the inner wall;
evacuating the insulation region to a pressure lower than atmospheric pressure; and
closing the insulation region by joining at least one of the one or more joining members to the outer wall.

13. A method according to claim 12, wherein the inner wall and outer wall comprise different materials.

14. A method according to claim 12, wherein the outer wall and the one or more joining members comprise similar materials.

15. A method according to claim 12, wherein the one or more joining members are end caps.

16. A method according to claim 12, wherein the one or more joining members are joined to at least one of: the inner wall and the outer wall, using brazing, welding, soldering, an adhesive or an interference fit.

17. A method according to claim 16, wherein brazing is performed using a silver eutectic brazing material.

18. A method according to claim 16, wherein the adhesive used is one of: a two-part epoxy, a one-part epoxy or an acrylic-based adhesive.

19. A method according to claim 18, wherein the adhesive is be cured by heat and/or ultraviolet light.

20. A method according to claim 1, wherein when the insulation region is evacuated to a pressure lower than atmospheric pressure, a region external to the insulation region is also evacuated to a pressure lower than atmospheric pressure.

21. A method according to claim 1, wherein the pressure lower than atmospheric pressure is 10⁻¹ Torr or lower.

22. A method according to claim 1, wherein the inner wall comprises mild steel or ferritic stainless steel.

23. A method according to claim 1, wherein the outer wall comprises one or more of: a non-susceptible metal, plastic, glass or ceramic.

24. A method according to claim 23, wherein the non-susceptible metal is stainless steel.

25. A thermal insulator manufactured according to claim 1.

26. A non-combustible aerosol provision device comprising:
a thermal insulator according to claim 25; and
a magnetic field generator for generating a varying magnetic field that penetrates the inner wall in order to heat the inner wall, in use.

27. A non-combustible aerosol provision system, comprising:
an apparatus according to claim 26; and
aerosol-generating material located at least partially within the heating zone of the inner wall of the thermal insulator, in use.
